(19) United States
(12) Patent Application Publication
(10) Pub. No.: US 2017/0109855 A1
(43) Pub. Date: Apr. 20, 2017

(54) SYSTEMS AND METHODS FOR DETECTING LINKAGES AMONG INDIVIDUALS

(71) Applicant: LexisNexis Risk Solutions FL Inc., Boca Raton, FL (US)

(72) Inventors: Steven Jeffrey Stockton, Suwanee, GA (US); Manish Rajnikant Shah, Norcross, GA (US); David Alan Bayliss, Delray Beach, FL (US)

(21) Appl. No.: 15/297,450

(22) Filed: Oct. 19, 2016

Related U.S. Application Data
(60) Provisional application No. 62/243,269, filed on Oct. 19, 2015.

(51) Int. Cl. G06Q 50/26; G06F 17/30

(52) U.S. Cl. CPC G06Q 50/265; G06F 17/30595; G06F 17/30386; G06F 17/30554

(57) ABSTRACT

Systems and methods are provided for determining relationships among individuals. The method can include receiving, from one or more sources, a plurality of records associated with a population of individuals; building a single database with the plurality of database records, each of the plurality of database records comprising a plurality of fields, each of the plurality of fields configured to include an associated field value; determining similarity among corresponding field values of the database records; producing a relationship database, based at least in part on the determining the similarity among corresponding field values of the database records; associating mutually matching database records; producing a relative database; and outputting database record information comprising a plurality of identifier pairs corresponding to individuals.

### CROSS REFERENCE TO RELATED APPLICATION

This application claims priority under 35 U.S.C. 119 to U.S. Provisional Patent Application No. 62/243,269, entitled “Systems and Methods for Detecting Linkages Among Individuals,” filed 19 Oct. 2015, the contents of which are incorporated by reference in their entirety as if fully set forth herein.

### FIELD OF THE DISCLOSED TECHNOLOGY

The disclosed technology generally relates to detecting linkages among individuals, and in particular, to systems and methods for detecting relationship linkages between individuals, their relatives, and/or associates.

### BACKGROUND OF THE DISCLOSED TECHNOLOGY

The growing human population combined with a plethora businesses and governmental agencies that interact with individuals can present numerous situations in which understanding the relationships among the individuals in the population may be desired or even critical. For example, an automobile insurance company may have limited information about an applicant before issuing an insurance policy. If the applicant has a clean driving record, but has been involved in numerous previous accidents while traveling in vehicles of friends or relatives, such information may be an indication of high risk, collusion, and/or fraud. Thus, such knowledge about the applicant's associates could be valuable.

Another example in which relationship knowledge may be applied is in the reduction of fraudulent activities such as identity theft, account takeover, and/or synthetic identity creation. Such activities can involve fraud rings having more than one perpetrator. However, such activities are difficult to detect and stop without relationship-linking information among the involved parties. Fraudsters, for example, can apply for credit, payments, benefits, tax refunds, etc., by misrepresenting their identity as another adult, a child, a relative, or even as a deceased person. The associated revenue loss to the businesses and/or government agencies can be significant, and the technical and emotional burden on the victim to rectify their public, private, and/or credit records can be onerous. In certain cases, by the time such fraudulent activity is discovered, the damage has already been done and the perpetrator has moved on. Technically well-informed fraud rings with sophisticated deception schemes are likely to continue developing, refining, and applying fraudulent schemes, particularly if relationship-linking fraud detection mechanisms are not in place.

### BRIEF SUMMARY OF THE DISCLOSED TECHNOLOGY

Some or all of the above needs may be addressed by certain embodiments of the disclosed technology. Certain embodiments of the disclosed technology may include systems and methods for detecting relationship linkages between individuals, their relatives, and/or associates.

According to an example embodiment of the disclosed technology, systems and methods are provided for determining relationships among individuals. In one example implementation, the method is provided that can include receiving, from one or more sources, a plurality of records associated with a population of individuals; building a single database with the plurality of database records, each of the plurality of database records comprising a plurality of fields, each of the plurality of fields configured to include an associated field value; determining similarity among corresponding field values of the database records; producing a relationship database, based at least in part on the determining the similarity among corresponding field values of the database records; associating mutually matching database records, wherein the associating comprises performing at least one matching iteration for each of the database records; producing a relative database, based at least in part on the associating the mutually matching database records; and outputting database record information comprising a plurality of identifier pairs corresponding to individuals, wherein the individual identifier pairs are based at least in part on a matching score exceeding a predetermined value.

In another example implementation, a system is provided. The system includes at least one memory for storing data and computer-executable instructions, and at least one special-purpose processor configured to access the at least one memory and further configured to execute the computer-executable instructions to: receive, from one or more sources, a plurality of records associated with a population of individuals; build a single database with the plurality of database records, each of the plurality of database records comprising a plurality of fields, each of the plurality of fields configured to include an associated field value; determine similarity among corresponding field values of the database records; produce a relationship database, based at least in part on the determined similarity among corresponding field values of the database records; associate mutually matching database records by performing at least one matching iteration for each of the database records; produce a relative database, based at least in part on the associating the mutually matching database records; and output database record information comprising a plurality of identifier pairs corresponding to individuals, wherein the individual identifier pairs are based at least in part on a matching score exceeding a predetermined value.

Other embodiments, features, and aspects of the disclosed technology are described in detail herein and are considered a part of the claimed disclosed technologies. Other embodiments, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a diagram 100 of an illustrative relationship-linking example and system, which utilizes a special-purpose computer 101 and special programming language(s) 118 for determining links between individuals, according to certain embodiments of the disclosed technology.

FIG. 2 is a block diagram 200 of an illustrative process for linking information from various data sources, according to an exemplary embodiment of the disclosed technology.

FIG. 3 is a diagram 300 depicting example linking of entities based on location and/or cohabitation, according to an example embodiment of the disclosed technology.

FIG. 4 is an illustrative example process 400 for clustering certain entity data, according to an exemplary embodiment of the disclosed technology.

FIG. 5 is a block diagram 500 of an illustrative linking process, according to an exemplary embodiment of the disclosed technology.

FIG. 6 is a block diagram 600 of an illustrative special-purpose computer system, according to an exemplary embodiment of the disclosed technology.

FIG. 7 is a flow diagram 700 of an illustrative method, according to an exemplary embodiment of the disclosed technology.

### DETAILED DESCRIPTION

Embodiments of the disclosed technology will be described more fully hereinafter with reference to the accompanying drawings, in which embodiments of the disclosed technology are shown. This disclosed technology may, however, be embodied in many different forms and should not be construed as limited to the embodiments set forth herein; rather, these embodiments are provided so that this disclosure will be thorough and complete, and will fully convey the scope of the disclosed technology to those skilled in the art.

According to certain example implementations of the disclosed technology, linking relationships among individuals may be detected by processing and/or analysis of certain data. Example implementations of the disclosed technology can utilize special-purpose computing systems and custom query language(s) in the processes described herein to provide meaningful results. Given the sheer amount of data to be tracked and analyzed, the special-purpose computing systems and/or custom query language(s) may provide the technological base for enabling certain embodiments disclosed herein.

Certain example implementations of the disclosed technology provide tangible improvements in computer processing speeds, memory utilization, and/or programming languages. Such improvements provide certain technical contributions that can enable the detection of relationships among individuals. In certain example implementations, the improved computer systems disclosed herein may enable analysis of an entire population, such as all known persons in the United States, together with associated activities. The computation of such a massive amount of data, at the scale required to provide effective outlier detection and information, has been enabled by the improvements in computer processing speeds, memory utilization, and/or programming language as disclosed herein. Those with ordinary skill in the art may recognize that traditional methods such as human activity, pen-and-paper analysis, or even traditional computation using general-purpose computers and/or off-the-shelf software, are not sufficient to provide the level of data processing for effective relationship-linking. As disclosed herein, the special-purpose computers and special-purpose programming language(s) disclosed herein can provide improved computer speed and/or memory utilization that provide an improvement in computing technology, thereby enabling the disclosed inventions.

Certain example implementations of the disclosed technology may be enabled by the use of a special purpose HPCC systems in combination with a special purpose software linking technology called Scalable Automated Linking Technology (SALT). SALT and HPCC, are developed and offered by LexisNexis Risk Solutions, Inc., the assignee of the disclosed technology. HPCC Systems, for example, provide data-intensive supercomputing platform(s) designed for solving big data problems. As an alternative to Hadoop, the HPCC Platform offers a consistent, single architecture for efficient processing. The SALT modules, in conjunction with the HPCC Systems, provides technical improvements in computer processing that enable the disclosed technology and provides useful, tangible results that may have previously been unattainable. For example, certain example implementation of the disclosed technology may process massive data sets, which are computationally intensive, requiring special software and hardware.

In accordance with certain example implementations, linking of records may be performed by certain additional special programming and analysis software. For example, record linking fits into a general class of data processing known as data integration, which can be defined as the problem of combining information from multiple heterogeneous data sources. Data integration can include data preparation steps such as parsing, profiling, cleansing, normalization, and parsing and standardization of the raw input data prior to record linkage to improve the quality of the input data and to make the data more consistent and comparable (these data preparation steps are sometimes referred to as ETL or extract, transform, load).

Some of the details for the use of SALT are included in the APPENDIX section of this application. According to an example implementation of the disclosed technology, SALT can provide data profiling and data hygiene applications to support the data preparation process. In addition SALT provides a general data ingest application which allows input files to be combined or merged with an existing base file. SALT may be used to generate a parsing and classification engine for unstructured data, which can be used for data preparation. The data preparation steps are usually followed by the actual record linking or clustering process. SALT provides applications for several different types of record linking including internal, external, and remote.

Data profiling, data hygiene and data source consistency checking, while key components of the record linking process, have their own value within the data integration process and may be supported by SALT for leverage even when record linking is not a necessary part of a particular data work unit.

SALT uses advanced concepts such as term specificity to determine the relevance/weight of a particular field in the scope of the linking process, and a mathematical model based on the input data, rather than the need for hand coded user rules, which may be key to the overall efficiency of the method.

Certain example implementations may utilize SALT to prevent fraud by verifying identities, addresses and other factors. Certain example implementations may utilize determined relationship information to detect collusive activities. Certain example implementations of the disclosed technology may be utilized to detect fraudulent activity, for example, as related to property and casualty insurance fraud, health care fraud, mortgage fraud, and/or questionable activity related to other financial services transactions.

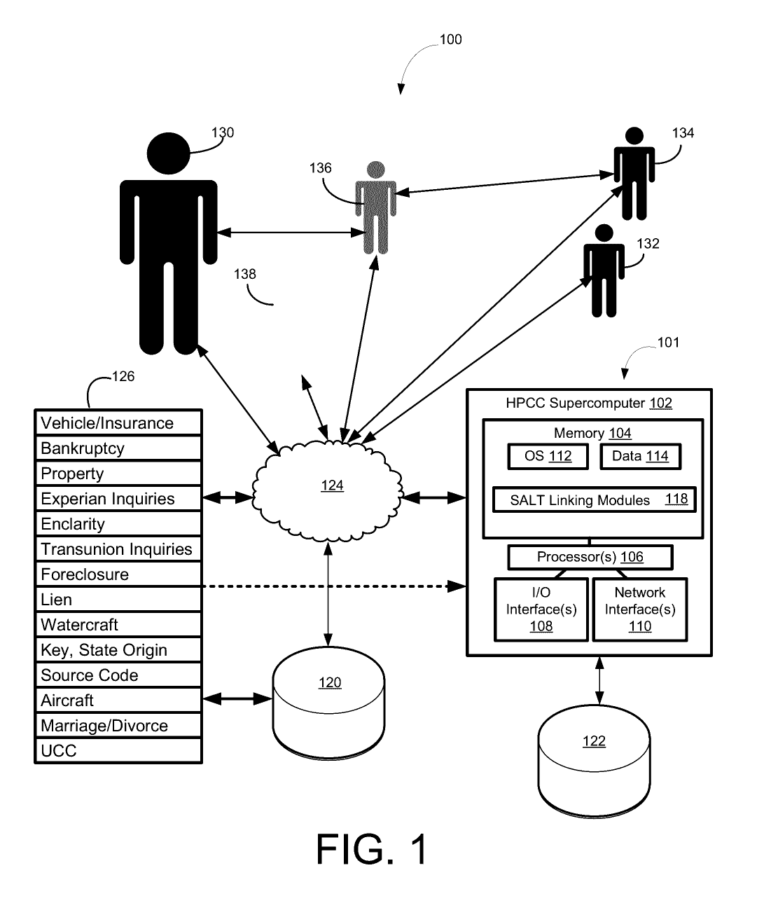

FIG. 1 is a block diagram 100 of an illustrative relationship-linking system 101 including an example process for determining relationship links between/among individuals. Certain example implementations of the disclosed technology are enabled by the use of a special-purpose HPCC supercomputer 102 and SALT 118, as described above, and as provided with further examples in the APPENDIX.

According to an example implementation of the disclosed technology, the system 101 may include a special-purpose supercomputer (which may include the HPCC supercomputer 102) in communication with one or more data sources and may be configured to process records 126 obtained from the various data sources 120 122. According to an example implementation, the computer 102 may include a memory 104, one or more processors 106, one or more input/output interface(s) 108, and one or more network interface(s) 110. In accordance with an exemplary embodiment, the memory 104 may include an operating system 112 and data 114. In certain example implementations, one or more record linking modules, such SALT 118 may be provided, for example, to instruct the one or more processors 106 to analyze and/or determine relationships within and among the records 126. Certain example implementations of the disclosed technology may further include one or more internal and/or external databases or sources 120 122 in communication with the computer 102. In certain example implementations, the records 126 may be provided by a source 120 122 in communication with the computer 102 directly and/or via a network 124 such as the Internet.

According to an example implementation of the disclosed technology, the various records 126 of a population of individuals may be processed to determine relationships and/or connections with a target individual 130. In accordance with an example implementation of the disclosed technology, the analysis may yield other individuals 132 134 136 138 that are directly or indirectly associated with the target individual 130. In certain example implementations, such relationships may include one or more of: one-way relationships, two-way relationships, first degree connections, second degree connections etc., depending on the number of intervening connections.

The example block diagram 100 and system 101 shown in FIG. 1 depicts a first individual 136 that is directly associated with the target individual 130 by a first-degree connection, such as may be the case for a spouse, sibling, known business associate, etc. Also shown, for example purposes, is a second individual 134 who is associated with the target individual 130 via a second degree connection, and who also is connected directly with the first individual 136 by a first degree connections. According to an exemplary embodiment, this type of relationship would tend to add more weight, verification, credibility, strength etc., to the connections. Put another way, such a relationship may strengthen the associated connection. The connection between the target individual 130 and the first individual 136 may be considered to be a connection having a degree less than one, for example, by virtue of the presence of the indirect relationship of the target individual 130 with the second individual 134 and the direct relationship between the target individual 130 and the first individual 136, where the strength of the connection may be inversely related to the degree of the connection.

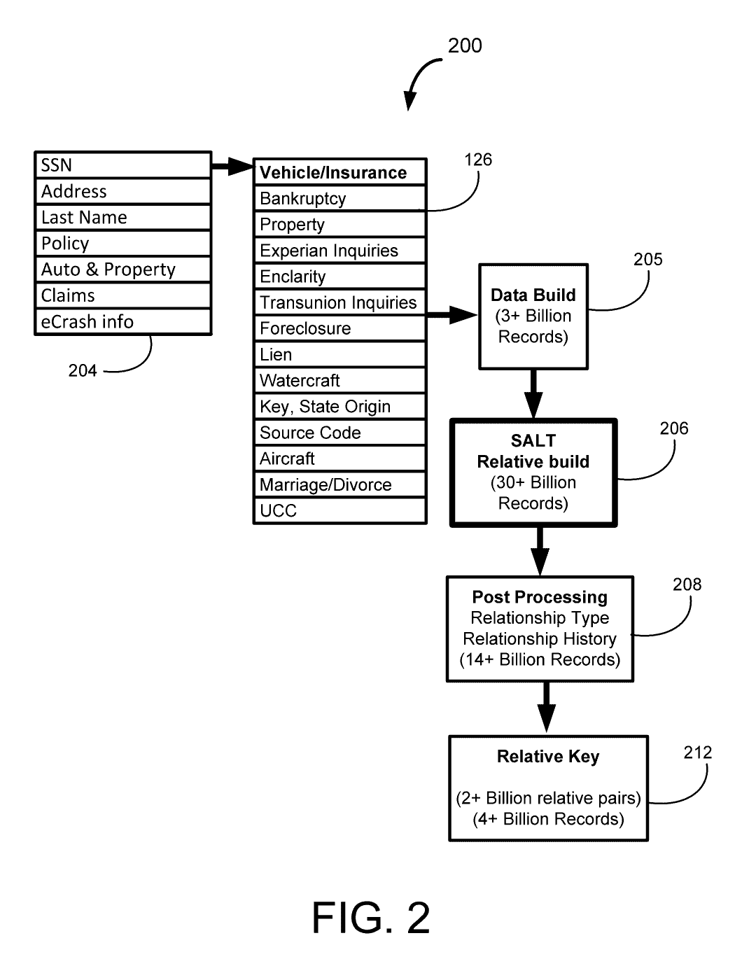

FIG. 2 is a block diagram 200 of an illustrative process for receiving and linking records 126 associated with a massive number of individuals, according to an exemplary embodiment of the disclosed technology. In an example implementation, the records 126 can be classified in a plurality of categories such as one or more of: vehicle records, insurance records, bankruptcy records, property records, credit bureau records (such as via TransUnion, Equifax, Experian, etc) health care records (such as via Enclarity), foreclosure records, lien records, watercraft records, aircraft records, marriage records, divorce records, Uniform Commercial Code records, state and/or local public records, etc.

Table 1 depicts relationship record examples including example source files, record origination (public/private sources), example key data, relationship description, and example count (number) of records. In accordance with an example implementation of the disclosed technology, the records summarized in this table may provide input for further processing by SALT.

TABLE 1
Relationship Records Examples

| Source File | | | Description of | |
|---|---|---|---|---|
| (aspects) | Orig. | Key Data | Relationship | Count |
| Vehicles | Public | Vehicle ID, Iteration, | Buyer/Seller; Co- | 648,488,127 |
| | Records | Sequence Key | Owners; Co-named | |
| | | | relationships; etc. | |
| Bankruptcies, | Public | TMS ID, Name Type | Individuals; Co- | 85,862,358 |
| Foreclosures, | Records | | named; etc. | |
| Liens | | | | |
| Property | Public | LN Fares ID, Source | Buyer/Buyer; | 830,762,525 |
| | Records | Code, Prim Name, | Seller/Seller; | |
| | | Prim Range | Buyer/Seller; etc. | |
| Experian | Public | Sequence Record ID, | Conamed on | 1,157,699,661 |
| Inquiries | Records | Prim Name, Prim | Experian inquiry | |
| | | Range | | |
| Enclarity | Public | Billing Group Key, | Doctors in same | 717,091 |
| | Records | Addr Key | practice/location | |
| TransUnion | Public | Vendor ID | Conamed on | 58,940,285 |
| Inquiries | Records | | Transunion inquiry | |
| Foreclosures | Public | Foreclosure ID, | Conamed on | 16,210,444 |
| | Records | Name Type | Foreclosure | |
| Liens | Public | TMS ID, Name Type | Conamed on Lien | 75,111,915 |
| | Records | | | |
| eCrash | Insurance | Ecrash Idfield, | In same vehicle | 28,927,935 |
| | | Vehicle Unit Number | during wreck; | |
| | | | individuals | |
| | | | involved in | |
| | | | accidents in | |
| | | | different vehicles; | |
| | | | etc. | |
| Watercraft | Public | Watercraft Key, | Co registered for | 10,901,185 |
| | Records | Sequence Key, State | watercraft | |
| | | Origin, Source Code | | |
| Aircraft | Public | N Number, Cert Issue | Co registered for | 45,399 |
| | Records | Date | aircraft | |
| Uniform | Public | TMS ID, RMS ID | Tied to same | 27,956,542 |
| Commercial | Records | | business tx | |
| Code | | | | |
| Marriage/ | Public | Record ID | Individuals | 13,408,762 |
| Divorce | Records | | married/divorced | |
| Policy | Insurance | Policy Number, | Share | 1,225,234,868 |
| | | AmBest | ambest/policy no | |
| Auto & | Insurance | Claim Number, | Share ambest/claim | 392,993,660 |
| Property | | AmBest | number | |
| Claims | | | | |
| SSN | Both | SSN | Share same SSN | 590,969,339 |
| Address | Both | Address | Share address | 13,647,447,086 |

In accordance with an example implementation of the disclosed technology, and with continued reference to FIG. 2, certain sub-records 204 may be included in, or used to generate the particular class of records 126. For example, the records 126 that are classified as vehicle/insurance records may be generated by, and/or may include sub-records 204 such as one or more of: social security number, address, last name, policy number, auto and property insurance information, claims, eCrash information, etc. In certain example implementations, vehicle ID, may be included in the sub-records 204. In certain example implementation, the Vehicle ID may be one of the Key Data items already provided, for example, in the Vehicles Source File as shown in Table 1. The eCrash information, for example, may include accident/crash information, such as all parties involved in accidents, including passengers. Such information may be used to provide links between individuals. In some instances, the eCrash information may help identify individuals who are involved in one or more accidents together, but who may not otherwise show up in any other linkages. Such information may be indicative of fraudulent activity.

With continued reference to the example of FIG. 2, and according to certain example implementations, the various records 126 (and those derived from sub-records 204), may include a massive number of records. In some instances, the number of records 126, when the initial data build 205 is assembled, can approach or exceed 3 billion records in number. In accordance with an example implementation of the disclosed technology, these records may be processed by SALT to produce a relative build 206 that can result in even more records and relationships. For example, in some instances, the number of records in the relative build 206, can approach or exceed 30 billion records in number.

In accordance with an example implementation of the disclosed technology, the relative build 206 records may be post-processed 208 to provide a reduced set of records (for example approximately 14 billion records). This reduction in the number of records can be a result of eliminating duplicates, scrubbing data, correcting data errors, removing records having low accuracy or linkage confidence etc. In certain example implementations, the reduced set of records can include relationship type, relationship history, linkages among individual IDs, etc. In accordance with an example implementation of the disclosed technology, the relative key 212 may be the output of relative linking process 200. For example, the relative key 212 information may further enable relationship data to be used at runtime.

Table 2 depicts an example of a linking matrix resulting from the SALT processing 206 and/or the post processing 208. For example, records associated with a first individual having a distinct identifier DID 1 (also known as a lexID) of 2536085885 may be compared with records of all other individuals in the datasets to determine matching/linking counts and scores for the various aspects as listed in the left-hand column header. For example, the first column in Table 2 summarizes linking scores/counts of the various aspects between DID 2536085885 and DID 660901755. The second column in Table 2 summarizes linking scores by the various aspects between DID 2536085885 and DID 952750500, and so forth. In this example implementation, DID 2 entities may be included in the matrix due to a score/count for one or more aspects having score/count above a predetermined threshold. For example, the DID 2 entities 4 and 5 (in the two right-most columns) may have been included simply because they live in the same apartment complex as DID 1 and they share similar last names. However, when all other matches are taken into consideration, the total score (which may be a strong indicator of a family or business relationship) may be relatively low for those just appearing in the same living community, but relatively high for individuals matching on other aspects, such as co-property, co-policy, co-vehicle, etc. In this relatively simple and limited example, as shown in Table 2, one may note that that DID 1 and DID 2 entity 2 (2^{nd} column) have a high probability as being related due to the high co-habitation score (157), the high co-habitation count (4 previous residences), the co-apartment score (38), the high co-policy score (108), the high co-property score (135), the high co-property count (5), the high co-vehicle score (27), and/or the last name score (14). In fact, the total linking score for DID 1 (2536085855) and DID 2 entity 2 (952750500) in this example is the highest (479) of all. As may also be seen in this linking example, the linking scores between DID 1 and DID 2 entities 1 (660901755) and 3 (1557475655) also show relatively high total scores, which may indicate a close family, personal, or business relationship between these entities.

TABLE 2
Linking Example

| | 1 | 2 | 3 | 4 | 5 |
|---|---|---|---|---|---|
| DID 1 | 2536085855 | 2536085855 | 2536085855 | 2536085855 | 2536085855 |
| DID 2 | 660901755 | 952750500 | 1557475655 | 1654343996 | 2536090283 |
| cohabit score | 89 | 157 | 89 | 31 | 31 |
| cohabit cnt | 3 | 4 | 3 | 1 | 1 |
| coapt score | 38 | 38 | 38 | 0 | 0 |
| coapt cnt | 1 | 1 | 1 | 0 | 0 |
| copobox score | 0 | 0 | 0 | 0 | 0 |
| copobox cnt | 0 | 0 | 0 | 0 | 0 |
| cossn score | 0 | 0 | 0 | 0 | 0 |
| cossn cnt | 0 | 0 | 0 | 0 | 0 |
| copolicy score | 27 | 108 | 27 | 0 | 0 |
| copolicy cnt | 1 | 4 | 1 | 0 | 0 |
| coclaim score | 0 | 0 | 0 | 0 | 0 |
| coclaim cnt | 0 | 0 | 0 | 0 | 0 |
| coproperty score | 0 | 135 | 162 | 0 | 0 |
| coproperty cnt | 0 | 5 | 6 | 0 | 0 |
| bcoproperty score | 0 | 0 | 0 | 0 | 0 |
| bcoproperty cnt | 0 | 0 | 0 | 0 | 0 |
| coforeclosure scr. | 0 | 0 | 0 | 0 | 0 |
| coforeclosure cnt | 0 | 0 | 0 | 0 | 0 |
| bcoforeclosure scr | 0 | 0 | 0 | 0 | 0 |
| bcoforeclosure | 0 | 0 | 0 | 0 | 0 |
| cnt | | | | | |
| colien score | 0 | 0 | 0 | 0 | 0 |
| colien cnt | 0 | 0 | 0 | 0 | 0 |
| bcolien score | 0 | 0 | 0 | 0 | 0 |
| bcolien cnt | 0 | 0 | 0 | 0 | 0 |
| cobankruptcy scr | 0 | 0 | 0 | 0 | 0 |
| cobankruptcy cnt | 0 | 0 | 0 | 0 | 0 |
| bcobankruptcy scr | 0 | 0 | 0 | 0 | 0 |
| bcobankruptcy | 0 | 0 | 0 | 0 | 0 |
| cnt | | | | | |
| covehicle score | 0 | 27 | 0 | 0 | 0 |
| covehicle cnt | 0 | 1 | 0 | 0 | 0 |
| coexperian score | 0 | 0 | 0 | 0 | 0 |
| coexperian cnt | 0 | 0 | 0 | 0 | 0 |
| cotransunion | 0 | 0 | 0 | 0 | 0 |
| score | | | | | |
| cotransunion cnt | 0 | 0 | 0 | 0 | 0 |
| coenclarity score | 0 | 0 | 0 | 0 | 0 |
| coenclarity cnt | 0 | 0 | 0 | 0 | 0 |
| coecrash score | 0 | 0 | 0 | 0 | 0 |
| coecrash cnt | 0 | 0 | 0 | 0 | 0 |
| bcoecrash score | 0 | 0 | 0 | 0 | 0 |
| bcoecrash cnt | 0 | 0 | 0 | 0 | 0 |
| cowatercraft score | 0 | 0 | 0 | 0 | 0 |
| cowatercraft cnt | 0 | 0 | 0 | 0 | 0 |
| coaircraft score | 0 | 0 | 0 | 0 | 0 |
| coaircraft cnt | 0 | 0 | 0 | 0 | 0 |
| comar/divorce scr | 0 | 0 | 0 | 0 | 0 |
| comar/divorce cnt | 0 | 0 | 0 | 0 | 0 |
| coucc score | 0 | 0 | 0 | 0 | 0 |
| coucc cnt | 0 | 0 | 0 | 0 | 0 |
| lname score | 17 | 14 | 17 | 13 | 13 |
| phone score | 0 | 0 | 27 | 26 | 26 |
| dl nbr score | 0 | 0 | 0 | 0 | 0 |
| total cnt | 4 | 15 | 10 | 1 | 1 |
| total score | 171 | 479 | 360 | 70 | 70 |
| cluster | CORE | CORE | CORE | CORE | CORE |
| generation | O | S | S | S | O |
| gender | M | M | M | F | F |
| lname cnt | 2 | 1 | 1 | 5 | 1 |
| rel dt first seen | 20070300 | 20020921 | 20070000 | 19971000 | 19971000 |
| rel dt last seen | 20141121 | 20080100 | 20150200 | 19980600 | 20140800 |
| overlap months | 92 | 64 | 98 | 8 | 202 |
| hdr dt first seen | 19840400 | 19971200 | 20000700 | 19910800 | 19710700 |
| hdr dt last seen | 20150200 | 20150204 | 20150200 | 20150200 | 20150200 |
| age first seen | 33 | 20 | 19 | 18 | 19 |
| lnamematch | TRUE | TRUE | TRUE | TRUE | TRUE |
| phonematch | FALSE | FALSE | FALSE | FALSE | FALSE |
| addr ind1 | 5 | 7 | 5 | 12 | 12 |
| addr ind2 | 94 | 12 | 4 | 4 | 1 |
| r2rdid | 1557475655 | 0 | 660901755 | 2536242643 | 2536242643 |
| r2cnt | 0 | 0 | 0 | 0 | 0 |
| personal | TRUE | TRUE | TRUE | TRUE | TRUE |
| business | FALSE | FALSE | FALSE | FALSE | FALSE |
| other | FALSE | FALSE | FALSE | FALSE | FALSE |

Returning now again to FIG. 2, in certain example implementations, pairs of records may then be derived after the post processing 208, for example to link individual IDs (with other individual IDs) for which linking confidence above a predetermined level is obtained, such as provided above in the example described in reference to Table 2. In certain example implementations, the resulting pairs of records may reduce the “possible relationships” count (for example, 14 billion records) that is produced in the post processing 208 to a further reduced data set for the relative key 212 (for example, 2 billion related pairs) having high confidence as being related. In an example implementation, records may be identified by social security number and/or lexID, and may be flagged for additional processing.

According to certain example implementations of the disclosed technology, record linking among individuals may be utilized to identify and/or distinguish possible fraud-related activity from normal activity associated with an entity or identity. For example, a person may fake an identity for non-fraudulent activities, such as to get a job or to move into an apartment, and such identity faking may not elicit detection because if its isolated nature and typical involvement of only one identity. However, a fraudster who creates (or steals) multiple identities to commit fraudulently activity en-masse could use a same or similar address for the identities, and certain implementations of the disclosed technology may be utilized to detect such activity.

Certain example implementations of the disclosed technology may measure relationship linking over time. For example, a record, aspect, and/or activity associated with a particular entity identifier (such as a universal entity identifier, lexID, DID, or similar record identifier) may be time-stamped, for example, to record the number of months the entity remains at a particular address. Certain example implementations of the disclosed technology may measure or track the entity records, aspects, and/or activities and various associations based on a given threshold of time.

In accordance with an example implementation, relationship linking may be calculated via graph analytics with the Knowledge Engineering Language (KEL) and/or SALT, as previously discussed, which may provide certain speed, efficiency, and/or memory utilization advantages over previous computation languages.

In accordance with certain example implementations of the disclosed technology, the measurement and analysis of relationship links can be used to identify crime rings. For example, criminals may steal and/or manufacture a large number of identities, and a portion of these identities may be related in some way, for which the criminals may have access or control.

In certain example implementations of the disclosed technology, “containers” may be created to store each of the related records, aspects, and/or activities (such as shown in TABLE 1), and they may be monitored, updated, and/or analyzed over time, for example, as people move in and out of an address. Certain example implementations of the disclosed technology can enable review of all known addresses of the entire U.S. population, measuring and tracking identities moving in and out of the addresses, and generating statistics.

At a high level, the disclosed technology may generate and utilize metrics to look at identities and their associated flow to/from addresses over time. Certain example implementations, may also look at how far people move to go from one address to another. In certain instances, people may not have a logical movement pattern. The disclosed technology may help gain a better understanding the movement of the entire population, not only in the U.S. but also abroad.

Certain example implementations of the disclosed technology may be utilized to detect when a large number of people move to an address at once. Such movement data may be indicative of fraud. However, there are also situations in which such data may represent non-fraudulent activity, such as a credit repair agency using its address for its clients, for example. In health care for example, there may be a tie between moving and increase or decrease in allergies, thus, there a situations in which people move en mass for health or seasonal reasons. However, certain example implementations may be utilized to detect indicators of large scale identity theft, for example as associated with governmental benefits, tax returns, Medicaid, credit abuse, etc., and such detection may be associated with people moving into the same address.

According to certain example implementation of the disclosed technology, a maximum distance that an individual has ever moved may be utilized, for example, to determine anomalous behavior when an individual shows up as moving a great distance, as previous movement patterns may be indicators for future movement. One metric that may be monitored, according certain example implementations of the disclosed technology, is the length in which an entity has stayed at a previous address. Utilizing this information can provide an early warning sign so that the anomalous behavior may be investigated and stopped before fraud damage can be done. In certain cases, it can take months for law enforcement or credit agencies to piece together data that would indicate fraudulent activity, and it is usually too late as the damage/theft may have already occurred.

Certain example implementations of the disclosed technology may provide cross checks and filtering to eliminate false positives. For example, military personnel may have a very high move-to distance, but college students may have a very low move-to distance. Certain example implementations of the disclosed technology may identify and flag certain groups of people to differentiate what may be normal for one group, but abnormal for another group. Certain example implementations can be utilized to spot the anomalies, either because of the distances moved, groups moving together, threshold settings, etc.

In accordance with an example implementation of the disclosed technology, individuals may be identified by a disambiguated entity identifier, including a year and month in which they show up in a public record and are associated with a particular aspect. In certain example implementations, the records, aspects, and/or activities may also be identified with a year and a month. In certain example implementations, the data may be analyzed together with all other data, and the resulting output may be an indication of anomalous behavior. For example, if a family moves, they will typically do it all at once, but some of the family members may be more prompt than others in updating records associated with the new local Department of Motor Vehicles. The fact that such information may not update all at once for an entire family may be indicative of normal behavior.

Certain example implementations of the disclosed technology may be utilized to detect large scale ID theft. For example, in one example implementation, all residential metrics may be processed and reviewed for outliers. For example, outliers may be determined as corresponding to data that is more than two standard deviations away from the statistical normal. In other example implementations, the threshold for the outliers may be set as desired to include or exclude certain data.

Certain example implementations of the disclosed technology may be utilized as an early detection mechanism. For example, data associated with known identity theft in the past may be utilized as a model for predicting patterns that may be indicative of future identity theft. For example, a known dead person who shows up in the data as migrating may be labeled as a Zombie, and as such, will almost certainly be related with fraudulent identity theft activity. Other indicators of fraud may include a high number of individuals (>100 for example) who applied for credit in the same day from a same address. Example implementations of the disclosed technology may be utilized to identify such activity.

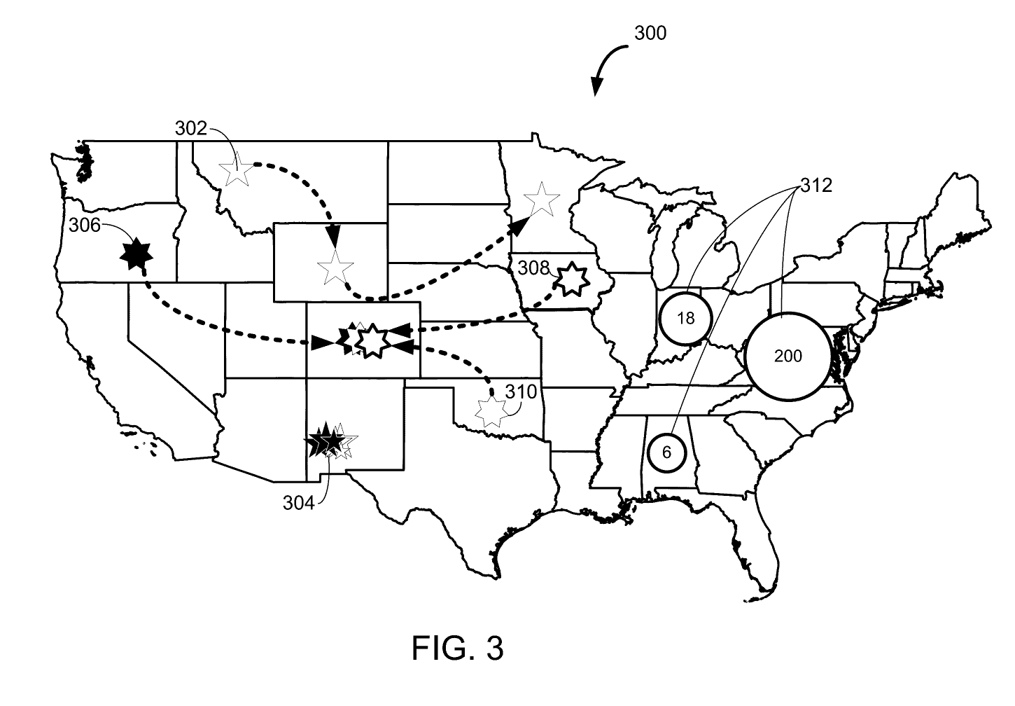

FIG. 3 is a diagram 300 of an illustrative example of how address or location information may be utilized, according to certain embodiments of the disclosed technology. Location data may be processed to determine certain aspects, metrics, scoring, etc., as associated with the entity, the time frame associated with a location, other entities moving to a same location, etc. For example, a first entity 302 (as depicted by the white star in FIG. 3) may be associated with a first address in Montana at a first time T1, a second address in Wyoming at a second time T2, and a third address in Minnesota at a third time T3. Based on this information, a pattern of address movement and overlap with possible associates may be determined. Such information alone may or may not provide an indication of potential fraud.

In another example implementation, the disclosed technology may be utilized to detect a first plurality of entities 304 (as depicted by dark stars located in New Mexico) that emerge at a same or similar location within a given time frame. For example, the first plurality of entities 304 may emerge at a certain address between times T4 and T5. In some instances, these entities 304 may not have an associated previous address. One explanation for the sudden emergence of the plurality of entities 304 at this location may be that a family of legal immigrants moved to the address within a given time frame. However, if corroborating information is not available (for example from U.S. Immigrations and Customs Enforcement or other previous entity records), then it may be likely that the plurality of entities 304 may be synthetically generated for fraudulent purposes. Yet in other example implementations, it may be possible to determine that these entities appeared to “emerge” at a given address because they started a first job in the U.S. without a prior public record. In accordance with an example implementation of the disclosed technology, age may be used to determine abnormal emergence. For example, in the case of migrant or foreign workers, the age at emergence is typically higher than that of a natural citizen.

In yet another example, and with continued reference to FIG. 3, a third entity 306 may be associated with an address in Oregon at a time T6; a forth entity 308 may be associated with an address in Iowa at a time T7; and a fifth entity 310 may be associated with an address in Oklahoma at a time T8. Then, each of these entities 306, 308, 310 may be associated with a same address in Colorado between times T9 and T10. Certain example implementations of the disclosed technology may be utilized to determine certain metrics for these entities. For example, and depending on certain metrics, the address in Colorado may be a school dormitory or apartment in a college town, each of the entities may be of typical college age, and they may “show up” at the destination address in Colorado at a time-frame between T9 and T10 which may correspond to a beginning of a school year. In such an example, and depending on the analysis of the associated metrics, such behavior may be scored with a low probability of fraud. However, in other example situations, the metrics associated with the entities may not fit such a safe scenario, such as students moving to go to college. For example, the entity ages may not fit the typical college student age, and thus, may be suspect.

FIG. 3 also depicts another way of graphically representing entity address data that has been identified by the disclosed systems and methods as being suspicious or possibly fraudulent. For example, bubbles 312 may be utilized to represent possible fraudulent activity associated with entities in a similar region. In certain example implementations, the diameter (or other numerical notations) associated with the bubbles 312 may represent the score of the likelihood of fraud. In certain example implementations, various metrics may be combined to provide indications or scores of the possible fraudulent activity.

Certain example implementations of the disclosed technology may enable identification of errors in data. For example, data provided by information vendors can include errors that, if left undetected, could produce erroneous results. Certain example implementations of the disclosed technology may be used to measure the accuracy and/or quality of the available data, for example by cross-checking, so that the data be included, scrubbed, corrected, or rejected before utilizing such data in the full analysis. In accordance with an example embodiment of the disclosed technology, such data quality may be determined and/or improved by cross checking, scrubbing to correct errors, and/or scoring to use or reject the data.

In accordance with an example implementation of the disclosed technology, connections and degrees of separation between entities may be utilized. For example, the connections may include a list of names of known or derived business associates, friends, relatives, etc. The degrees of separation may be an indication of the strength of the connection. For example, two people having a shared residence may result in a connection with a degree of 1. In another example implementation, two people working for the same company may have a degree of 2. In one example implementation, the degree of separation may be inversely proportional to the strength of the connection. In other example embodiments, different factors may be contribute to the degree value, and other values besides integers may be utilized to represent the connection strength.

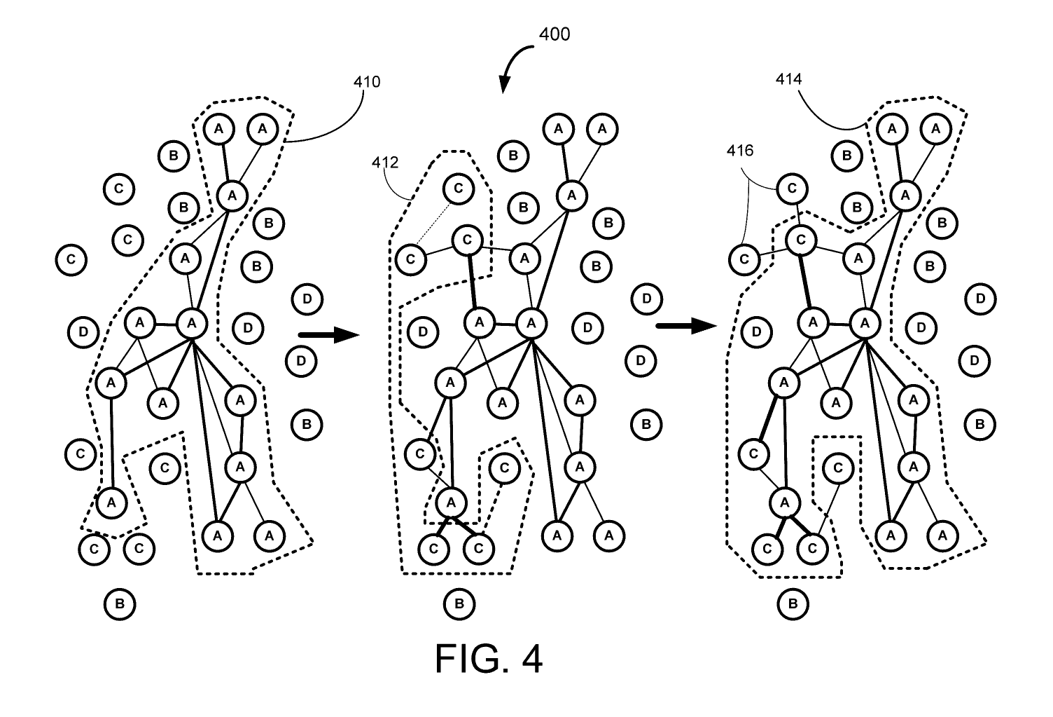

FIG. 4 is a graphical example of a clustering and co-convergence process, according to an example implementation of the disclosed technology. The circles shown in FIG. 4 may depict available database record representations corresponding to two or more different attributes or aspects (A, B, C, D . . . ). Such records may be in a single record set, or they may be received or otherwise derived from two or more record sets or sources. Such database record representations may be processed to determine linkages or relationships among the records and/or entities. The “relationships” among the various records (nodes) may be represented (for illustration purposes) as connecting lines (edges), with line weights representing different types of relationships and/or weightings among field values of the database records.

In certain example embodiments, each of the record data representations (circles or nodes) may include or represent multiple fields (not shown in FIG. 4), and may therefore be represented as nodes in a hyperspace. In one example implementation, the record data representations may relate to entities, such as people, and may include fields (such as Last Name, First Name, Address, Social Security Number, etc.,) with corresponding field values (such as Smith, John, 45 Broad Street, 543-21-1111). In another example implementation, the record data representations may represent entities such as an organization, and may include fields such as corporate offices, branches, locations, products, managers, employees, etc., with corresponding field values. In other example embodiments, the record data representations may include data representations from two or more different record sets. For example, the data may include representations from one set of records that represent people (with fields such as Last Name, First Name, Address, Social Security Number, etc.,) and the data may include representations from another set of records that represent businesses (with fields such as corporate offices, branches, locations, products, etc.).

According to certain example implementations, each available record data representation may correspond to an entity representation and may include a plurality of fields, each field configured to contain a field value, and each field value assigned a field value weight corresponding to a specificity of the field value in relation to all field values in a corresponding field of the records.

In accordance with an example implementation, for any particular given record attribute, the general process of clustering records may be refined with each iteration by assuming that all the other records and relationships are correct, performing one clustering iteration, then moving on to the next record attribute, performing one clustering iteration, and so forth. For example, the record data representations may be evaluated with respect to a particular attribute and/or aspect, and a cluster of records may be identified as having certain quantitative or qualitative relationships to the particular attribute of interest.

An example of an initial cluster 410 is depicted in the left-hand side of FIG. 4 within the dotted outline to distinguish the records having similar aspects or attributes of the cluster 410 from the remaining records. The initial clustered records 410, as depicted in this example, are shown sharing a common attribute identifier: “A,” along with connection weights that may represent any number of scenarios, according to certain example embodiments of the disclosed technology. For example, the “A” identifier and the connecting edges may represent certain commonalities with respect to the identifier evaluated in the clustering iteration (such as exact or partial matches of a last name).

The middle cluster in FIG. 4 depicts another cluster in which a new cluster 412 is formed having records identified with “C” attributes or aspects. The right-hand cluster in FIG. 4 represents a re-clustering iteration process, according to an example implementation of the disclosed technology, in which records are identified with both “A” and “C” attributes or aspects to form a new cluster 414 To arrive at the new cluster 414 (and not explicitly shown in FIG. 4), example embodiments may utilize a first iteration process whereby records with “A” attributes are clustered while noting relationships (edges and weights, for example) between those records having “C” attributes, and vice-versa. For example, starting with the initial cluster 410, attributes or commonalities (represented by connecting edges) may be evaluated to aggregate one or more relationships between any two entities. As depicted in 410, and based on relationships and/or other criteria among the records, the new cluster 414 formed in the re-clustering step may include certain records of the first iteration clusters 410 412 while omitting certain records 416.

In general terms, and in accordance with an example implementation, the available records may be initially clustered into a first set of clusters having corresponding first cluster identifications (IDs), and each record may include one or more field values. For example, records may be clustered according to the various identifications, such as “A,” “B,” “C,” “D,” etc., as indicated in FIG. 4. In accordance with an example implementation, and as discussed above, the initial clustering iteration(s) may be based at least in part on determining similarity among corresponding field values of database records. In an example implementation, mutually matching records may be associated by performing at least one matching iteration for each of the records, based at least in part on the cluster IDs. In an example implementation, the matching iteration may include linking related database records based at least in part on a determined match value. In another example implementation, the matching iteration may include linking related database records, based at least in part on determined mutually preferred records. In an example implementation, the clustering may include a process of determining similarity among corresponding field values of the database records.

According to an example implementation of the disclosed technology, the iteration process may include re-clustering at least a portion of the database records into a second set of clusters (for example, the cluster 414) having a corresponding second cluster ID. In an example implementation, the re-clustering may be based, at least in part, on associating mutually matching attributes of the initial clusters. In another example implementation, the re-clustering may be based, at least in part, on determining similarity among corresponding field values of the database records.

In one example implementation, the initial clustering may include associating mutually matching database records, which may include determining highest compelling linkages among the database records, which may further include identifying mutually preferred pairs of records from the database records, each mutually preferred pair of records consisting of a first record and a second record, the first record consisting of a preferred record associated with the second record and the second record consisting of a preferred record associated with the first record. In an example implementation, the mutually preferred pairs of records may be assigned a match score that meets pre-specified match criteria.

In an example implementation, the iteration process may also include assigning, for each record from the database records, at least one associated preferred record, wherein a match value assigned to a given record together with its associated preferred record is at least as great as a match value assigned to the record together with any other record in the database records. In an example implementation, the iteration process may also include forming and storing a plurality of entity representations in the database, each entity representation of the plurality of entity representations including at least one linked pair of mutually preferred records.

According to an example implementation of the disclosed technology, determining similarity among the corresponding field values of the records may include assigning a hyperspace attribute to each record. The hyperspace attribute that corresponds to two database records may correlate with a similarity of the corresponding field values of the two database records. In certain example embodiments, membership of each database record in a plurality of hyperspace clusters may be determined based at least in part on the hyperspace attributes. According to an example implementation each record may be assigned a cluster ID and a match value reflecting a likelihood that the record is a member of a particular hyperspace cluster, and related records may be linked based at least in part on the cluster ID and match value (as depicted by the edges joining the nodes in FIG. 4). Determining membership of each database record in the plurality of hyperspace clusters, for example, may include creating a plurality of nodes at random locations in hyperspace, each node maintaining records in hyperspace based on the hyperspace attribute for which it is the closest node.

In accordance with certain implementations of the disclosed technology duplicate records (for example, ones that are likely to represent the same entity) may be eliminated by merging those database records that have hyperspace attribute differences within a predefined criteria, resulting in a reduced set of database records. In accordance with an example implementation, the process may further include recalculating the field value weights for the reduced set of database records, and re-clustering the reduced set of records based at least in part on the recalculated field value weights.

According to an example implementation, of the disclosed technology, the clustering, iterating, recalculating, and re-clustering etc. may produce a set of refined clusters in which the records in a given set possess criteria that resemble the other records in the set. Such clustering may provide useful characteristics, categories, structures, etc., for understanding the interrelations among records in a database, and may further be used to define characteristics, categories, structures, etc., for new data as it becomes available.

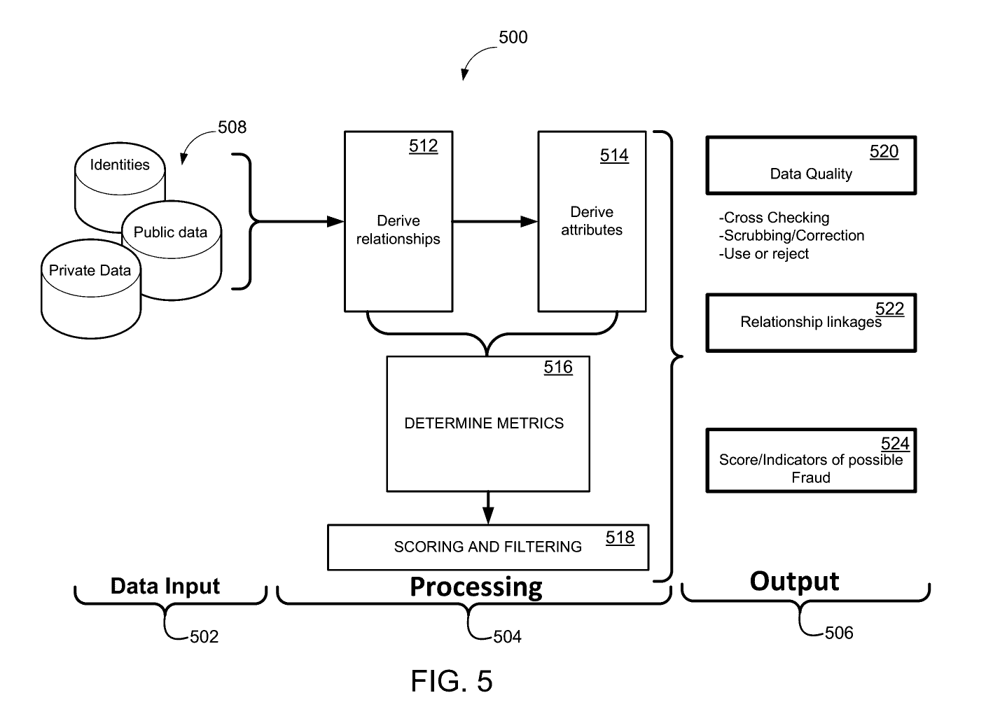

FIG. 5 is a block diagram depicting a certain example implementation 500 of the disclosed technology, which may include phases, such as data input 502, processing 504, and output 506. According to an example embodiment, a plurality of data sources and types 508 may be utilized to derive relationships 512 and attributes 514 among associated records. In certain example implementations, the relationships 512 and attributes 514 may be used to determine metrics 516, and such metrics may be utilized for scoring and filtering 518 the records and associated data.

In an example implementation, the output 506 may be based on data quality 520, and may include relationship linkages 522. In certain example implementations, indicators of possible fraud 524 may be output. According to an example implementation of the disclosed technology, the indicators of possible fraud 524 may be based on additional scoring. In an example implementation, a scoring unit may utilize a predetermined scoring algorithm for scoring some or all of the data. In another example implementation, the scoring unit may utilize a dynamic scoring algorithm for scoring some or all of the data. The scoring algorithm, for example, may be based on seemingly low-risk events that tend to be associated with organizations, such as fraud organizations. The algorithm may thus also be based on research into what events tend to be indicative of fraud in the industry or application to which the system is directed.

In accordance with an example implementation of the disclosed technology, publicly available data may be utilized as input data 508, which may include several hundred million records. Certain example implementations may clean and standardize data to reduce the possibility that matching entities are considered as distinct. Before creating a graph, certain example implementations may use this data to build a large-scale network map of the population in question with associated attributes, linkages, relationships, etc.

According to an example implementation, and as previously described, the relatively large-scale of supercomputing power and analytics may enable identifying organized collusion. Example implementation of the disclosed technology of the systems and methods disclosed herein may rely upon large scale, special-purpose, parallel-processing computing platforms to increase the agility and scale of solutions.

Example implementations of the disclosed technology of the systems and methods disclosed herein may measure behavior, activities, and/or relationships to actively and effectively expose syndicates and rings of collusion. Unlike many conventional systems, the systems and methods disclosed herein need not be limited to activities or rings operating in a single geographic location, and it need not be limited to short time periods. The systems and methods disclosed herein may be used to determine whether activities fall within an organized ring or certain geographical location.

In one example implementation, a filter may be utilized to reduce the data set to identify groups that evidence the greatest connectedness based on the scoring algorithm. In one example implementation, systems and methods disclosed herein may utilize scores that match or exceed a predetermined set of criteria and the associated records may be flagged for evaluation and/or additional processing. In an example implementation of the disclosed technology, filtering may utilize one or more target scores, which may be selected based on the scoring algorithm. In one example implementation, geo-social networks having scores greater than or equal to a target score may be flagged as being potentially collusive.

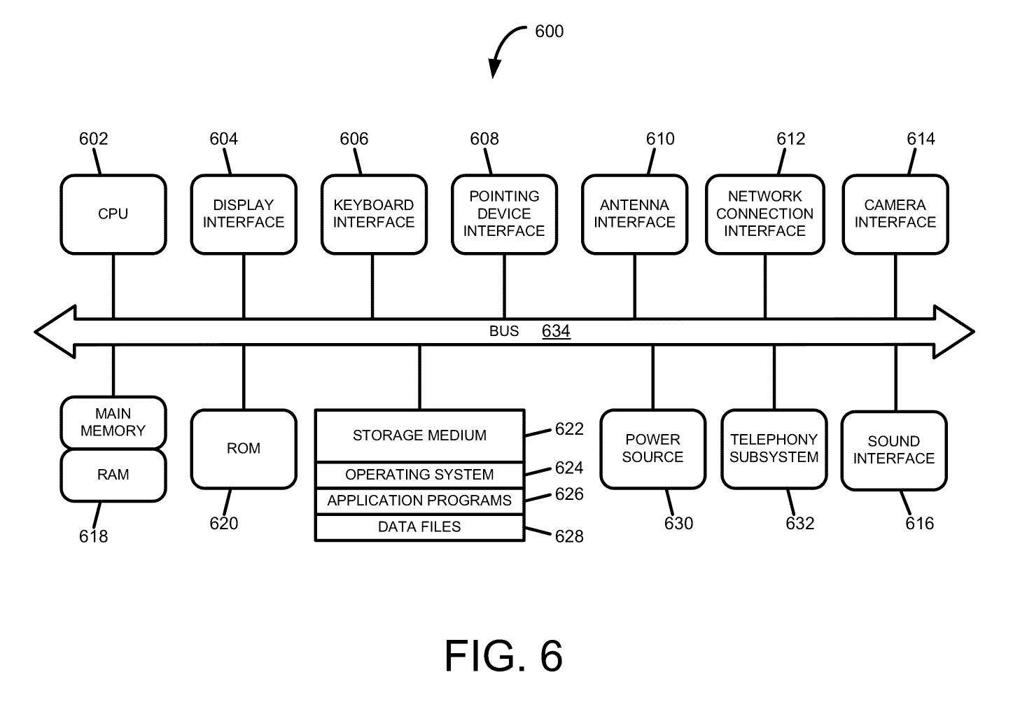

FIG. 6 depicts a computing device or computing device system 600, according to various example implementations of the disclosed technology. It will be understood that the computing device 600 is provided for example purposes only and does not limit the scope of the various implementations of the communication systems and methods. In certain example implementations, the computing device 600 may be a specialized HPCC Systems, as developed and offered by LexisNexis Risk Solutions, Inc., the assignee of the disclosed technology. HPCC Systems, for example, provide data-intensive supercomputing platform(s) designed for solving big data problems. Various implementations and methods herein may be embodied in non-transitory computer readable media for execution by a processor.

The computing device 600 of FIG. 6 includes a central processing unit (CPU) 602, where computer instructions are processed; a display interface 604 that acts as a communication interface and provides functions for rendering video, graphics, images, and texts on the display. In certain example implementations of the disclosed technology, the display interface 604 may be directly connected to a local display, such as a touch-screen display associated with a mobile computing device. In another example implementation, the display interface 604 may be configured for providing data, images, and other information for an external/remote display that is not necessarily physically connected to the mobile computing device. For example, a peripheral device monitor may be utilized for mirroring graphics and other information that is presented on a wearable or mobile computing device. In certain example implementations, the display interface 604 may wirelessly communicate, for example, via a Wi-Fi channel or other available network connection interface 612 to an external/remote display.

In an example implementation, the network connection interface 612 may be configured as a communication interface and may provide functions for rendering video, graphics, images, text, other information, or any combination thereof on the display. In an example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

The computing device 600 may include a keyboard interface 606 that provides a communication interface to a keyboard. In an example implementation, the computing device 600 may include a pointing device interface 608, which may provide a communication interface to various devices such as a pointing device, a touch screen, a depth camera, etc.

The computing device 600 may be configured to use an input device via one or more of input/output interfaces (for example, the keyboard interface 606, the display interface 604, the pointing device interface 608, network connection interface 612, camera interface 614, sound interface 616, etc.,) to allow a user to capture information into the computing device 600. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device 600 or may be a separate device. For example, the input device may be an accelerometer, a magnetometer, a digital camera, a microphone, and an optical sensor.

Example implementations of the computing device 600 may include an antenna interface 610 that provides a communication interface to an antenna; a network connection interface 612 that provides a communication interface to a network. As mentioned above, the display interface 604 may be in communication with the network connection interface 612, for example, to provide information for display on a remote display that is not directly connected or attached to the system. In certain implementations, a camera interface 614 may be provided to act as a communication interface and provide functions for capturing digital images from a camera. In certain implementations, a sound interface 616 is provided as a communication interface for converting sound into electrical signals using a microphone and for converting electrical signals into sound using a speaker. According to example implementations, a random access memory (RAM) 618 is provided, where computer instructions and data may be stored in a volatile memory device for processing by the CPU 602.

According to an example implementation, the computing device 600 includes a read-only memory (ROM) 620 where invariant low-level system code or data for basic system functions such as basic input and output (I/O), startup, or reception of keystrokes from a keyboard are stored in a non-volatile memory device. According to an example implementation, the computing device 600 includes a storage medium 622 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 624, application programs 626 (including, for example, KEL (Knowledge Engineering Language), SALT, a web browser application, a widget or gadget engine, and or other applications, as necessary) and data files 628 are stored. According to an example implementation, the computing device 600 includes a power source 630 that provides an appropriate alternating current (AC) or direct current (DC) to power components. According to an example implementation, the computing device 600 includes and a telephony subsystem 632 that allows the device 600 to transmit and receive sound over a telephone network. The constituent devices and the CPU 602 communicate with each other over a bus 634.

In accordance with an example implementation, the CPU 602 has appropriate structure to be a computer processor. In an arrangement, the computer CPU 602 may include more than one processing unit. The RAM 618 interfaces with the computer bus 634 to provide quick RAM storage to the CPU 602 during the execution of software programs such as the operating system application programs, and device drivers. More specifically, the CPU 602 loads computer-executable process steps from the storage medium 622 or other media into a field of the RAM 618 in order to execute software programs. Data may be stored in the RAM 618, where the data may be accessed by the computer CPU 602 during execution. In an example configuration, the device 600 includes at least 128 MB of RAM, and 256 MB of flash memory.

The storage medium 622 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 600 to access computer-executable process steps, application programs and the like, stored on removable and non-removable memory media, to off-load data from the device 600 or to upload data onto the device 600. A computer program product, such as one utilizing a communication system may be tangibly embodied in storage medium 622, which may comprise a machine-readable storage medium. Certain example implementations may include instructions stored in a non-transitory storage medium in communication with a memory, wherein the instructions may be utilized to instruct one or more processors to carry out the instructions.

According to one example implementation, the term computing device, as used herein, may be a CPU, or conceptualized as a CPU (for example, the CPU 602 of FIG. 6). In this example implementation, the computing device (CPU) may be coupled, connected, and/or in communication with one or more peripheral devices, such as display. In another example implementation, the term computing device, as used herein, may refer to a mobile computing device, such as a smartphone or tablet computer. In this example embodiment, the computing device may output content to its local display and/or speaker(s). In another example implementation, the computing device may output content to an external display device (e.g., over Wi-Fi) such as a TV or an external computing system.

In certain embodiments, the communication systems and methods disclosed herein may be embodied in non-transitory computer readable media for execution by a processor. An example implementation may be used in an application of a mobile computing device, such as a smartphone or tablet, but other computing devices may also be used, such as to portable computers, tablet PCs, Internet tablets, PDAs, ultra mobile PCs (UMPCs), etc.

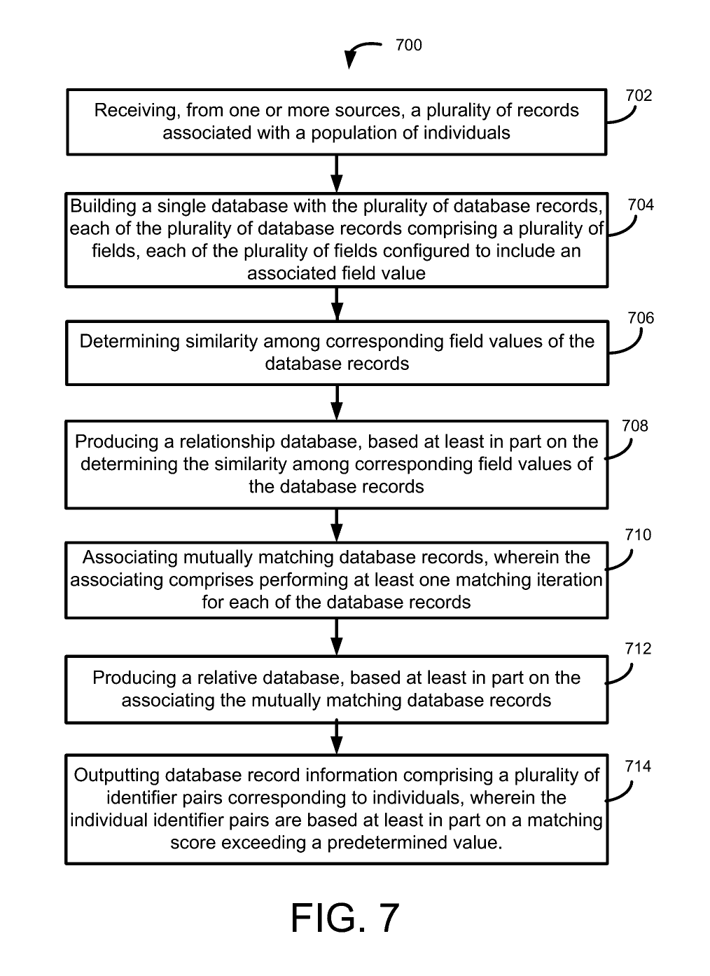

An exemplary method 700 for determining relationships among individuals is presented in the flowchart of FIG. 7. The method 700 starts in block 702, and according to an exemplary embodiment of the disclosed technology, includes receiving, from one or more sources, a plurality of records associated with a population of individuals. In block 704, the method 700 includes building a single database with the plurality of database records, each of the plurality of database records comprising a plurality of fields, each of the plurality of fields configured to include an associated field value. In block 706, the method 700 includes determining similarity among corresponding field values of the database records. In block 708, the method 700 includes producing a relationship database, based at least in part on the determining the similarity among corresponding field values of the database records. In block 710 the method 700 includes associating mutually matching database records, wherein the associating comprises performing at least one matching iteration for each of the database records. In block 712 the method 700 includes producing a relative database, based at least in part on the associating the mutually matching database records. In block 714 the method 700 includes outputting database record information comprising a plurality of identifier pairs corresponding to individuals, wherein the individual identifier pairs are based at least in part on a matching score exceeding a predetermined value.

Certain example embodiments of the disclosed technology may utilize a model to build a profile of indicators of fraud that may be based on multiple variables. In certain example implementations of the disclosed technology, the interaction of the indicators and variables may be utilized to produce one or more scores indicating the likelihood or probability of fraud associated with identity theft. For example, in one aspect, addresses associated with an identity and their closest relatives or associates may be may be analyzed to determine distances between the addresses. The greater distance may indicate a higher the likelihood of fraud because, for example, a fraudster may conspire with a relative or associate in another city, and may assume that their distance may buffer them from detection.

Certain example embodiments of the disclosed technology may utilize profile information related to an entity's neighborhood. For example, information such as density of housing (single family homes, versus apartments and condos), the presence of businesses, and the median income of the neighborhood may correlate with a likelihood of fraud. For example, entities living in affluent neighborhoods are less likely to be involved with fraud, whereas dense communities with lower incomes and lower presence of businesses may be more likely to be associated with fraud.

Certain example embodiments of the disclosed technology may assesses the validity of the input identity elements, such as the name, street address, social security number (SSN), phone number, date of birth (DOB), etc., to verify whether or not requesting entity input information corresponds to a real identity. Certain example implementations may utilize a correlation between the input SSN and the input address, for example, to determine how many times the input SSN has been associated with the input address via various sources. Typically, the lower the number, then the higher the probability of fraud.

Certain example implementations of the disclosed technology may determine the number of unique SSNs associated with the input address. Such information may be helpful in detecting identity theft-related fraud, and may also be helpful in finding fraud rings because the fraudsters have typically created synthetic identities, but are requesting all payments be sent to one address.

Certain example implementations may determine the number of SSNs associated with the identity in one or more public or private databases. For example, if the SSN has been associated with multiple identities, then it is likely a compromised SSN and the likelihood of fraud increases.

According to an example implementation, the disclosed technology may be utilized to verify the validity of the input address. For example, if the input address has never been seen in public records, then it is probably a fake address and the likelihood of fraud increases.

Certain example implementations of the disclosed technology may be utilized to determine if the container data corresponds to a deceased person, a currently incarcerated person, a person having prior incarceration (and time since their incarceration), and/or whether the person has been involved in bankruptcy. For example, someone involved in a bankruptcy may be less likely to be a fraudster.

Certain embodiments of the disclosed technology may enable the detection of possible, probable, and/or actual identity theft-related fraud, for example, as associated with a request for credit, payment, or a benefit. Certain example implementations provide for disambiguating input information and determining a likelihood of fraud. In certain example implementations, the input information may be received from a requesting entity in relation to a request for credit, payment, or benefit. In certain example implementations, the input information may be received from a requesting entity in relation to a request for an activity from a governmental agency.

In accordance with an example implementation of the disclosed technology, input information associated with a requesting entity may be processed, weighted, scored, etc., for example, to disambiguate the information. Certain implementations, for example, may utilize one or more input data fields to verify or correct other input data fields.

In an exemplary embodiment, a request for an activity may be received by the system. For example, the request may be for a tax refund. In one example embodiment, the request may include a requesting person's name, street address, and social security number (SSN), where the SSN has a typographical error (intentional or unintentional). In this example, one or more public or private databases may be searched to find reference records matching the input information. But since the input SSN is wrong, a reference record may be returned matching the name and street address, but with a different associated SSN. According to certain example implementations, the input information may be flagged, weighted, scored, and/or corrected based on one or more factors or metrics, including but not limited to: fields in the reference record(s) having field values that identically match, partially match, mismatch, etc, the corresponding field values.

Example embodiments of the disclosed technology may reduce false positives and increase the probability of identifying and stopping fraud based on a customized identity theft-based fraud score. According to an example implementation of the disclosed technology, a model may be utilized to process identity-related input information against reference information (for example, as obtained from one or more public or private databases) to determine whether the input identity being presented corresponds to a real identity, the correct identity, and/or a possibly fraudulent identity.

Certain example implementations of the disclosed technology may determine or estimate a probability of identity theft-based fraud based upon a set of parameters. In an example implementation, the parameters may be utilized to examine the input data, such as name, address and social security number, for example, to determine if such data corresponds to a real identity. In an example implementation, the input data may be compared with the reference data, for example, to determine field value matches, mismatches, weighting, etc. In certain example implementations of the disclosed technology, the input data (or associated entity record) may be scored to indicate the probability that it corresponds to a real identity.

In some cases, a model may be utilized to score the input identity elements, for example, to look for imperfections in the input data. For example, if the input data is scored to have a sufficiently high probability that it corresponds to a real identity, even though there may be certain imperfections in the input or reference data, once these imperfections are found, the process may disambiguate the data. For example, in one implementation, the disambiguation may be utilized to determine how many other identities are associated with the input SSN. According to an example implementation, a control for relatives may be utilized to minimize the number of similar records, for example, as may be due to Jr. and Sr. designations.

In an example implementation, the container data may be utilized to derive a date-of-birth, for example, based on matching reference records. In one example implementation, the derived date-of-birth may be compared with the issue date of the SSN. If the dates of the SSN are before the DOB, then the flag may be appended for this record as indication of fraud.

Another indication of fraud that may be determined, according to an example implementation, includes whether the entity has previously been associated with a different SSN. In an example implementation, a “most accurate” SSN for the entity may be checked to determine whether the entity is a prisoner, and if so the record may be flagged. In an example implementation, the input data may be checked against a deceased database to determine whether the entity has been deceased for more than one or two years, which may be another indicator of fraud.

### Scoring:

In accordance with certain example embodiments of the disclosed technology, a score may be produced to represent how closely input data matches with other available (reference) data. For example, input data may correspond to a request for a benefit or payment. The reference data, according to an example implementation, may be one or more records, each record including one or more fields having field values, and derived from one or more public or private databases. In certain example implementations, the reference data may be the best data available, in that it may represent the most accurate data in the databases. For example, the reference data may have been cross verified among various databases, and the various records and/or fields may be scored with a validity score to indicate the degree of validity.

In certain example implementations of the disclosed technology, the scores that represent how closely input data matches with the reference data scores may range from 0 to 100, with 0 being worst and 100 being best. In other example implementations, a score of 255 may indicate a null value for the score, for example, to indicate that it is not a valid score and should not be read as indicating anything about the goodness of the match.

In certain example implementations, the scoring used for the relationships may not range exclusively from 0 to 100. For example, weights may be based on the specificity of a particular aspect or item, and on the number of matching components.

According to an example implementation, two types of scores may be utilized: hard scores and fuzzy scores, as known by those of skill in the art. Fuzzy scores, for example are dependent on multiple factors and the same score may mean different things.

In accordance with an example implementation, certain scores may be common across all types of verification scores. For example a “0” may represent a very poor match, or a total mismatch, while a “100” may represent a perfect match. According to an example implementation a “255” may indicate a null (or invalid) comparison. In some cases such a null designation may be due to missing data, either in the input data or in the reference data.

For example, a null in the address score may indicate certain types of invalid addresses or missing information, while a “100” may represent a perfect match across primary and secondary address elements. In certain example implementations of the disclosed technology, a score in the range of “1-90” may be representative of a fuzzy range of scores that mean primary elements of the address disagree in ways ranging from serious to minor. Higher scores are better, with 80 or higher generally considered a “good match,” and lower scores increasingly less similar, and with “0” representing a total miss.

According to an example implementation other scores may be dependent on the type of matching being done. For example, with regard to the phone number, a “255” may represent a blank input phone number, a blank reference phone number, or both being blank. In an example implementation, a “100” may indicate that the last 7 digits of the input and reference phone numbers are an exact match, while a “0” may represent any other condition.

With regard to the SSN, and according to an example implementation a “255” may represent a blank input SSN, a blank reference SSN, or both being blank: one side or the other is blank. In an example implementation, if neither of the SSNs (input or reference) are blank, then a computed score may be determined as 100 minus a ‘similarity score’. For example, the computed scored may result in a perfect match of “100” if ‘similarity score’ is 0, and generally speaking, a very close match may result in a computed score of 80 or 90, while a 70 may be considered a possible match.

According to an example implementation, an entity's date of birth (DOB) may be scored by comparing the input data with reference data. In one example implementation the standard format for dates may be represented by a year, month, day format (yyyymmdd). In certain example implementations of the disclosed technology, null values may be referenced or identified by scores of 00 or 01. In an example implementation, a “255” may represent invalid or missing DOB data in the input data, the reference data, or both while a “100” may represent a perfect yyyymmdd match. According to an example implementation, “80” may represent that yyyymm are the same and the day data (dd) is null in the input data, the reference data, or both. According to an example implementation, “60” may represent that yyyymm are the same, but the days are different in the input an reference data, but not null. According to an example implementation, “40” may represent that yyyy are the same, but mmdd in the input data, the reference data, or both is null. According to an example implementation “20” may represent that yyyy are the same, but the in the input data the reference data differ by month and day. Finally a “0” score may represent that there is no match between in the input DOB data and the reference DOB data.

With regard to the name, a “255” may represent a blank input name, a blank reference name, or both being blank, or no first, middle, or last name. Otherwise the score may be computed similarly to SSN. For example, a name match algorithm may be applied to the input and reference names, and the various qualities of matches may range from a perfect match (with a verify score of 100) to a poor match (with a verify score of 50) to no match (with a score of 0).

### Scoring Examples

In accordance with an example implementation, a name scoring may be utilized to determine how close the input names (first, middle and last) match to the reference name.

| Input Name | Best Name | Score |
|---|---|---|
| ‘RICHARD L TAYLOR’, | ‘RICHARD L TAYLOR’ | 100 |
| ‘RICH L TAYLOR’, | ‘RICHARD L TAYLOR’ | 90 |
| ‘RICH TAYLOR’, | ‘RICHARD L TAYLOR’ | 80 |
| ‘ROD L TAYLOR’, | ‘RICHARD L TAYLOR’ | 0, (believed to be |
| | | another person). |

In an example implementation, the SSN score may be used to determine how similar the input SSN is to the reference SSN.

| Input SSN | Reference SSN | Score |
|---|---|---|
| ‘ABCDEFGHI’, | ‘ABCDEFGHI’, | 100 |
| ‘ABCDEFGHZ’, | ‘ABCDEFGHI’, | 90 |
| ‘ABCDEFGZZ’, | ‘ABCDEFGHI’, | 80 |
| ‘ABCDEFZZZ’, | ABCDEFGHI’, | 70 |
| ‘ABCDEZZZZ’, | ‘ABCDEFGHI’, | 60 |
| ‘ABCDZZZZZ’, | ‘ABCDEFGHI’, | 40 |
| ‘ZZZZZFGHI’, | ‘ABCDEFGHI’, | 40 |

Certain embodiments of the disclosed technology may enable the detection of connections among individuals. According to an example implementation of the disclosed technology, input information, together with associate information obtained from sources such as public or private databases, may be utilized to determine if the relationship(s) are possible indicators of fraud, or if they are legitimate.

Certain embodiments of the disclosed technology may enable detection of various requests for payment, benefit, service, refund, etc. from a government agency or entity. The government agency, as referred to herein, may include any government entity or jurisdiction, including but not limited to federal, state, district, county, city, etc. Embodiments of the disclosed technology may be utilized to detect fraud associated with non-government entities. For example, embodiments of the disclosed technology may be utilized by various businesses, corporations, non-profits, etc., to detect fraud.

In certain example implementations of the disclosed technology, receiving the plurality of independent information includes receiving the one or more records comprising one or more of housing records, vehicular records, marriage records, divorce records, hospital records, death records, court records, property records, incarceration records, tax records, and utility records, wherein the utility records comprise one or more of utility hookups, disconnects, and associated service addresses.

In an example implementation, the one or more public or private databases are independent of the government agency.

According to exemplary embodiments, certain technical effects are provided, such as creating certain systems and methods that detect relationships among entities or individuals. Exemplary embodiments of the disclosed technology can provide the further technical effects of providing systems and methods for determining and eliminating false positives with respect to fraud. Certain example embodiments include technical effects of providing systems and methods for disambiguating input information, resulting in higher quality determinations of fraudulent activities.

In exemplary embodiments of the disclosed technology, the various systems described herein may include any number of hardware and/or software applications that are executed to facilitate any of the operations. In exemplary embodiments, one or more I/O interfaces may facilitate communication between the fraud detection system 101 and/or the fraud detection system architecture 600 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the fraud detection system 101 and/or the fraud detection system architecture 600. The one or more I/O interfaces may be utilized to receive or collect data and/or user instructions from a wide variety of input devices. Received data may be processed by one or more computer processors as desired in various embodiments of the disclosed technology and/or stored in one or more memory devices.

One or more network interfaces may facilitate connection of the fraud detection system 101 and/or the fraud detection system architecture 600 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ enabled network, a Wi-Fi™ enabled network, a satellite-based network any wired network, any wireless network, etc., for communication with external devices and/or systems.

As desired, embodiments of the disclosed technology may include the fraud detection system 101 and/or the fraud detection system architecture 600 with more or less of the components illustrated in FIG. 1 and FIG. 6.

Certain embodiments of the disclosed technology are described above with reference to block and flow diagrams of systems and methods and/or computer program products according to exemplary embodiments of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Numerous specific details have been set forth in this description of the various implementations of the disclosed technology. However, it is to be understood that embodiments of the disclosed technology may be practiced without these specific details. In other instances, well-known methods, structures and techniques have not been shown in detail in order not to obscure an understanding of this description. The term “exemplary” herein is used synonymous with the term “example” and is not meant to indicate excellent or best. References to “one embodiment,” “an embodiment,” “exemplary embodiment,” “various embodiments,” “implementation,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

As used herein, the terms “entity” and “identity” may mean the same thing.

While certain embodiments of the disclosed technology have been described in connection with what is presently considered to be the most practical and various embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer-implemented method, comprising:
receiving, from one or more sources, a plurality of records associated with a population of individuals;
building a single database with the plurality of database records, each of the plurality of database records comprising a plurality of fields, each of the plurality of fields configured to include an associated field value;
determining similarity among corresponding field values of the database records;
producing a relationship database, based at least in part on the determining the similarity among corresponding field values of the database records;
associating mutually matching database records, wherein the associating comprises performing at least one matching iteration for each of the database records;
producing a relative database, based at least in part on the associating the mutually matching database records; and
outputting database record information comprising a plurality of identifier pairs corresponding to individuals, wherein the individual identifier pairs are based at least in part on a matching score exceeding a predetermined value.

2. The method of claim 1, further comprising:
determining, with the one or more special-purpose computer processors, and based at least in part on the individual identifier pairs, one or more indicators of identity theft fraud; and
outputting, for display, the one or more indicators of the identity theft fraud.

3. The method of claim 1, wherein the plurality of records comprise one or more of: vehicle records, insurance records, bankruptcy records, property records, credit bureau records, health care records, foreclosure records, lien records, watercraft records, aircraft records, marriage records, divorce records, Uniform Commercial Code records, state records, and local public records.

4. The method of claim 1, wherein the determining similarity among the corresponding field values of the database records comprises:
assigning an attribute to each database record, wherein the attribute corresponding to two database records is correlated with a similarity of the corresponding field values of the two database records;
determining membership of each database record in a plurality of clusters based at least in part on the attributes;
assigning, to each record, a cluster ID and a match value reflecting a likelihood that the record is a member of a particular cluster; and
linking related records based at least in part on the cluster ID and match value.

5. The method of claim 4, further comprising merging database records having attribute differences within a predefined criteria to eliminate similar exemplars that are likely to represent a same entity, the merging resulting in a reduced set of database records.

6. The method of claim 6, further comprising:
recalculating the field value weights for the reduced set of database records; and
re-clustering the reduced set of records based at least in part on the recalculated field value weights.

7. The method of claim 4, wherein the determining membership of each database record in the plurality of clusters further comprises creating a plurality of nodes at random locations in a hyperspace, each node maintaining records in the hyperspace based on the hyperspace attribute for which it is the closest node.

8. The method of claim 1, wherein the associating mutually matching database records further comprises:
determining highest compelling linkages among the database records, the determining comprising:
identifying mutually preferred pairs of records from the database records, each mutually preferred pair of records consisting of a first record and a second record, the first record consisting of a preferred record associated with the second record and the second record consisting of a preferred record associated with the first record, wherein the mutually preferred pairs of records each has a match score that meets pre-specified match criteria;
assigning, for each record from the database records, at least one associated preferred record, wherein a match value assigned to a given record together with its associated preferred record is at least as great as a match value assigned to the record together with any other record in the database records; and
forming and storing a plurality of entity representations in the database, each entity representation of the plurality of entity representations comprising at least one linked pair of mutually preferred records.

9. The method of claim 1, wherein each database record corresponds to an entity representation, each database record comprising a plurality of fields, each field configured to contain a field value, and each field value assigned a field value weight corresponding to a specificity of the field value in relation to all field values in a corresponding field of the records.

10. The method of claim 1, wherein performing the at least one matching iteration comprises linking related database records based at least in part on a determined match value or determined mutually preferred records.

11. A system comprising:
at least one memory for storing data and computer-executable instructions; and
at least one special-purpose processor configured to access the at least one memory and further configured to execute the computer-executable instructions to:
receive, from one or more sources, a plurality of records associated with a population of individuals;
build a single database with the plurality of database records, each of the plurality of database records comprising a plurality of fields, each of the plurality of fields configured to include an associated field value;
determine similarity among corresponding field values of the database records;
produce a relationship database, based at least in part on the determining the similarity among corresponding field values of the database records;
associate mutually matching database records by performing at least one matching iteration for each of the database records;
produce a relative database, based at least in part on the associating the mutually matching database records; and
output database record information comprising a plurality of identifier pairs corresponding to individuals, wherein the individual identifier pairs are based at least in part on a matching score exceeding a predetermined value.

12. The system of claim 11, wherein at least one special-purpose processor is further configured to execute the computer-executable instructions to:
determine, based at least in part on the individual identifier pairs, one or more indicators of identity theft fraud; and
output, for display, the one or more indicators of the identity theft fraud.

13. The system of claim 11, wherein the plurality of records comprise one or more of: vehicle records, insurance records, bankruptcy records, property records, credit bureau records, health care records, foreclosure records, lien records, watercraft records, aircraft records, marriage records, divorce records, Uniform Commercial Code records, state records, and local public records.

14. The system of claim 11, wherein the similarity among the corresponding field values of the database records is determined by:
assigning an attribute to each database record, wherein the attribute corresponding to two database records is correlated with a similarity of the corresponding field values of the two database records;
determining membership of each database record in a plurality of clusters based at least in part on the attributes;
assigning, to each record, a cluster ID and a match value reflecting a likelihood that the record is a member of a particular cluster; and
linking related records based at least in part on the cluster ID and match value.

15. The system of claim 14, wherein at least one special-purpose processor is further configured to execute the computer-executable instructions to merge database records having attribute differences within a predefined criteria to eliminate similar exemplars that are likely to represent a same entity, the merging resulting in a reduced set of database records.

16. The system of claim 15, wherein at least one special-purpose processor is further configured to execute the computer-executable instructions to:
recalculate the field value weights for the reduced set of database records; and
re-cluster the reduced set of records based at least in part on the recalculated field value weights.

17. The system of claim 14, wherein the membership of each database record in the plurality of clusters is determined be creating a plurality of nodes at random locations in a hyperspace, each node maintaining records in the hyperspace based on the hyperspace attribute for which it is the closest node.

18. The system of claim 11, wherein the mutually matching database records are further associated by:
determining highest compelling linkages among the database records, the determining comprising:
identifying mutually preferred pairs of records from the database records, each mutually preferred pair of records consisting of a first record and a second record, the first record consisting of a preferred record associated with the second record and the second record consisting of a preferred record associated with the first record, wherein the mutually preferred pairs of records each has a match score that meets pre-specified match criteria;
assigning, for each record from the database records, at least one associated preferred record, wherein a match value assigned to a given record together with its associated preferred record is at least as great as a match value assigned to the record together with any other record in the database records; and
forming and storing a plurality of entity representations in the database, each entity representation of the plurality of entity representations comprising at least one linked pair of mutually preferred records.

19. The system of claim 11, wherein each database record corresponds to an entity representation, each database record comprising a plurality of fields, each field configured to contain a field value, and each field value assigned a field value weight corresponding to a specificity of the field value in relation to all field values in a corresponding field of the records.

20. The system of claim 11, wherein the at least one matching iteration is performed by linking related database records based at least in part on a determined match value or determined mutually preferred records.
